(19) United States
(12) Patent Application Publication
(10) Pub. No.: US 2002/0069094 A1
(43) Pub. Date: Jun. 6, 2002

(54) System and method of reserving meeting facility resources

(76) Inventors: Glenn G. Bingham, Henderson, NV (US); Edward B. Warburton, Las Vegas, NV (US)

Correspondence Address: Justin M. Dillon, BLAKELY, SOKOLOFF TAYLOR & ZAFMAN LLP, 7th Floor, 12400 Wilshire Boulevard, Los Angeles, CA, 90025, US

(21) Appl. No.: 09/729,051

(22) Filed: Dec. 4, 2000

(51) Int. Cl. G06F 17/60

(52) U.S. Cl. 705/5

(57) ABSTRACT

A system and method for reserving resources for a meeting is disclosed. A meeting package having multiple meeting facility resources such as hotel guest rooms, meeting rooms, or food or beverage service is defined for a meeting facility. A reservation request is then received from a user selecting the meeting package. After the meeting package has been requested, each resource of the meeting package is reserved for the user. A customer profile associated with the user may be used to determine the price of the meeting package or its component resources. The meeting package may be defined or reserved based on various meeting facility criteria input by the user, real-time facility inventory data, or facility reservation rules.

### FIELD OF THE INVENTION

The field of the invention relates generally to meeting and event planning and to computer networking and electronic commerce. More particularly, the field of the invention relates to an improved system and method of reserving meeting facility resources for meetings, conferences, conventions, and other group-related events.

### BACKGROUND OF THE INVENTION

The planning of a group-related meetings or events such as conventions, conferences, or trade shows at present is a complicated, time-consuming, and inefficient process. Meeting planners using the current process are compelled to plan meetings far in advance of the scheduled event date. While this long-term planning makes the availability of meeting facility resources easy to ascertain, the pricing of meeting facility resources far in the future is usually not favorable to meeting planners unless it falls during a period of historically low utilization or occupancy. Moreover, meeting plans typically depend on a variety of factors and must often be changed as the scheduled meeting date approaches.

In the past meeting planners or organizers would first specify a desired meeting location such as a particular city or metro area, a preferred date or dates for the meeting or event, and any necessary or preferred resources, amenities or services for a meeting. Next, the organizer would determine which meeting facilities in the desired geographic area had the capability to provide the specified resources, amenities or services. Finally, the organizer would contact those meeting facilities to determine the facility's actual availability on the desired dates, modifying malleable meeting requirements as necessary, to request and negotiate bids or proposals, and to secure, reserve, or purchase selected resources and services such as meeting room space, hotel guestrooms, food and/or beverage service, and the like.

The advent of computer networks such as the Internet and particularly the World Wide Web (WWW) has improved some aspects of the meeting planning process. Systems are known, for example, which include computer network interfaces such as web sites or web pages which provide access to meeting site information and services over the Internet to meeting planners. Such sites are provided utilizing web, application, and file or database servers and accessed by meeting planners via web browser client applications, allowing a meeting planner to enter a list of meeting site requirements for a meeting. These meeting site requirements are then used to query a database of meeting facility information to estimate an all-inclusive cost for a meeting at several facilities satisfying all of the planner-specified requirements. Meeting planners may interact with these web sites to determine which meeting facilities have adequate capacity, amenities, or services in a given geographic area and to compare facilities based on an estimated overall meeting cost. This allows the number of potential meeting sites and consequently the number of facilities which must be contacted to be reduced.

No information is provided by these web sites however, on the actual availability of a given meeting facility or the actual, final cost of the desired resources. As a result, the amount of time needed for meeting planning may actually be increased when meeting facilities with inadequate availability or unattractive prices are presented to a meeting planner as viable meeting sites. Another shortcoming of these web sites is that they fail to reduce the amount of time spent generating requests for proposals or bids, waiting to receive responsive bids or proposals, or negotiating with contacted meeting sites. One known improvement that improves these aspects of meeting planning is the use of electronic requests for proposals (RFPs).

Once one or more potential meeting sites have been compared and selected using one of the above-described meeting planning web sites, an electronic proposal request is generated and transmitted to each of the selected meeting sites via electronic mail, fax, or other transmission means. While the use of such electronic RFPs decreases the amount of time required to contact potential meeting sites initially, the time needed to receive proposals or bids from meeting sites in response to such electronic requests, to determine actual meeting site availability, and to negotiate pricing or other proposal details is still extremely lengthy. Still other systems are known which include web sites allowing users to reserve a small number of hotel guestrooms over a specified range of dates in real-time. Such web sites are not well-suited for use by meeting planners however in that they typically allow only hotel guestrooms and not other resources or services to be secured and do not allow more than a small number of hotel guestrooms to be reserved at one time.

Accordingly, there is a need for an improved system and method of reserving meeting facility resources for meetings, conferences, conventions, and other group-related events facilitating shorter-term meeting planning.

### SUMMARY OF THE INVENTION

The present invention is a system and method for reserving resources for a meeting. A meeting package having multiple meeting facility resources such as hotel guest rooms, meeting rooms, or food or beverage service is defined for a meeting facility. A reservation request is then received from a user selecting the meeting package. After the meeting package has been requested, each resource of the meeting package is reserved for the user. A customer profile associated with the user may be used to determine the price of the meeting package or its component resources. The meeting package may be defined or reserved based on various meeting facility criteria input by the user, real-time facility inventory data, or facility reservation rules.

### BRIEF DESCRIPTION OF THE DRAWINGS

The present invention is illustrated by way of example and not limitation in the figures of the accompanying drawings, in which

FIG. 1 illustrates a system diagram of a communications network of the present invention.

FIG. 2a illustrates a conventional data processing system useable with the present invention.

FIG. 2b illustrates a prior art architecture of the data processing system depicted in FIG. 2a.

FIG. 3 illustrates a high-level block diagram of the meeting package reservation server of FIG. 1.

FIG. 4 illustrates a high-level logic flowchart of one embodiment of the method of the present invention.

FIG. 5 illustrates a high-level logic flowchart depicting one embodiment of the definition of a meeting package shown in FIG. 4.

FIGS. 6-14 illustrate display output of a browser client application according to one embodiment of the present invention.

### DETAILED DESCRIPTION OF THE PREFERRED EMBODIMENT

An Internet-based system and method for reserving meeting facility resources for a meeting is disclosed. In the following detailed description, numerous specific details are set forth in order to provide a thorough understanding of the present invention. However, it will be apparent to one of ordinary skill in the art that these specific details need not be used to practice the present invention. In other circumstances, well-known structures, materials, circuits, processes and interfaces have not been shown or described in detail in order not to unnecessarily obscure the present invention.

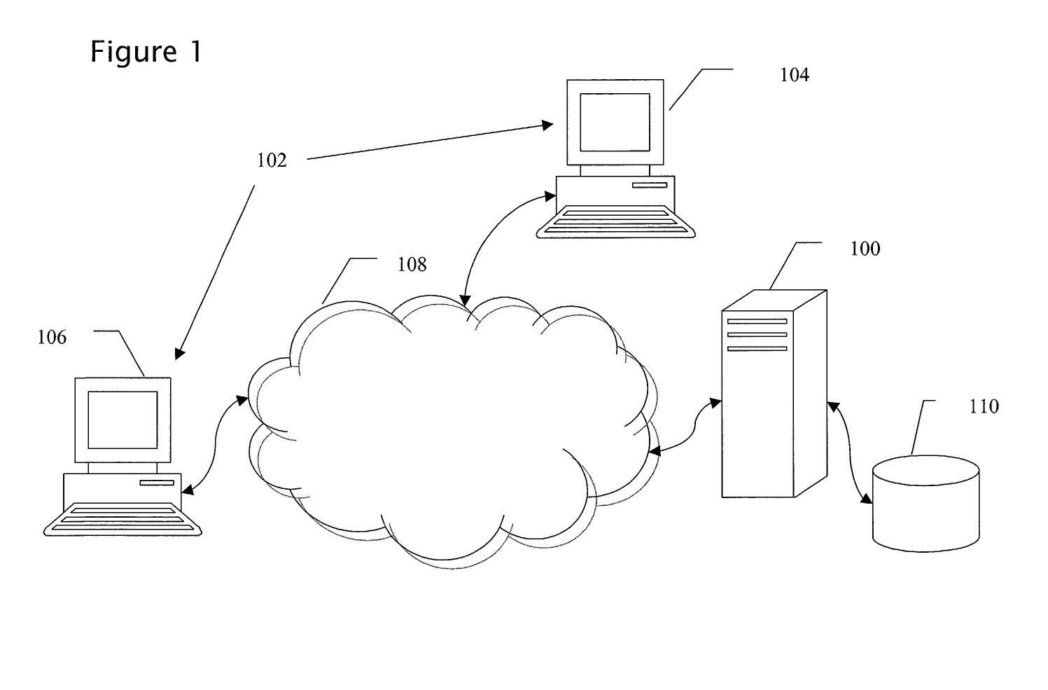

Referring now to FIG. 1, a system diagram of a communications network used with the present invention is illustrated. According to one embodiment of the present invention the network topology depicted in FIG. 1 includes a server, such as meeting package reservation server 100 coupled to and in communication with a storage device 110 via a database server (not illustrated), as well as with various clients 102, such as meeting facility client 104 and meeting planner client 106, via a network 108. It should be appreciated by those having ordinary skill in the network-related arts that clients 102 and server 100 may be coupled to network 108 in a variety of ways including through direct or dial-up telephone or other network transmission lines, using a modem pool (not illustrated), or through an additional network and gateway (not illustrated). In one embodiment of the present invention, meeting package reservation server 100 includes a web server and an application server to provide meeting package reservation functionality to meeting planners. Using the Hypertext Transfer Protocol (HTTP) and Hypertext Markup Language (HTML) or Extensible Markup Language (XML) code across network 108, server 100 communicates with clients 102 to facilitate this functionality.

Utilizing conventional web browser client applications such as Netscape™ Navigator™ published by Netscape™ Corporation of Mountain View, Calif., the Internet Explorer™ published by Microsoft™ Corporation of Redmond, Wash., the user interface of America Online™, or the web browser or HTML/XML translator of any other well-known supplier, clients 102 may supply data to, and access processed or unprocessed data from server 100 and may also run server-provided, Web-based application software. It will be appreciated by those having ordinary skill in the network-related arts that network 108 may be organized as either a wide-area (WAN) or local-area (LAN) network, and may be administered as a private network (an intranet), a public network (the Internet), or a combination of private and public networks (an extranet).

According to one embodiment of the present invention, the information communicated between clients 102 and meeting package reservation server 100 includes reservation rules, reservation quotas, and inventory data associated with a meeting facility, as well as customer profiles associated with particular meeting planners which are stored within storage device 110. In another embodiment, the information communicated includes meeting facility criteria and reservation requests for generated meeting packages. It will be readily appreciated by those having ordinary skill in the relevant arts that storage device 110 may include various mass store devices such as one or more DASD arrays, tape drives, optical drives, or the like, and that the aforementioned information may be stored in any one of a variety of formats or data structures.

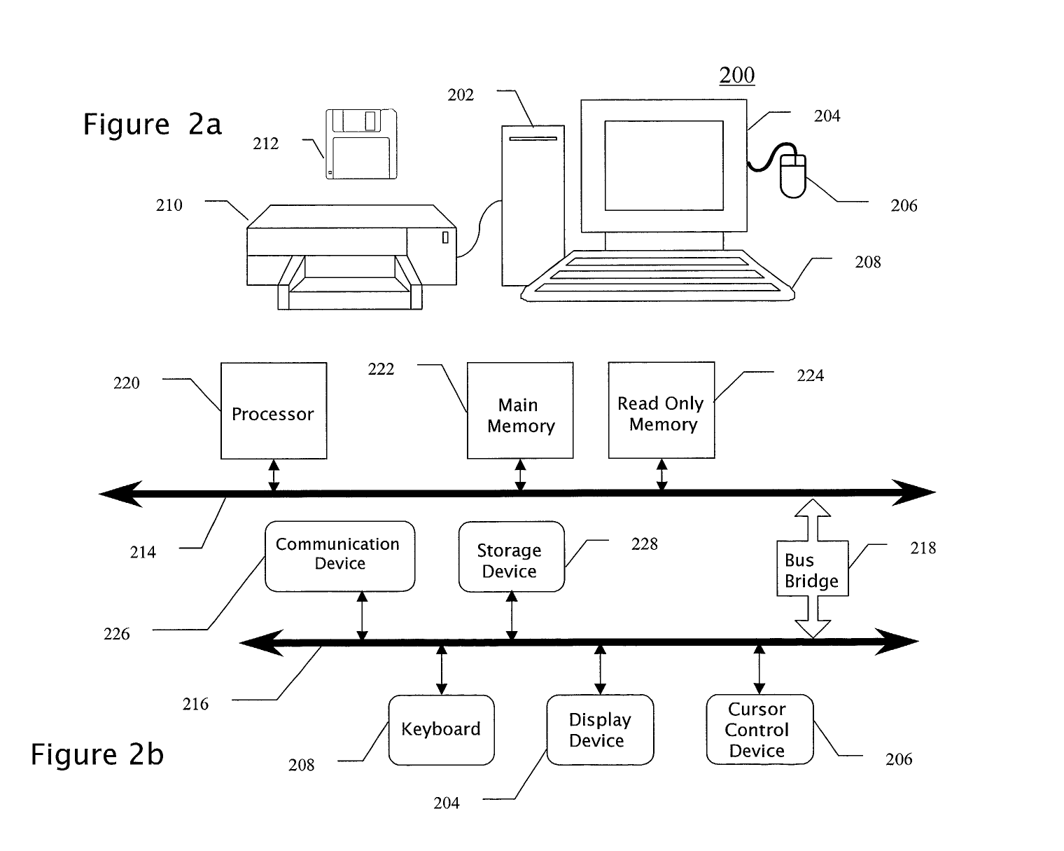

Having briefly described one embodiment of the network environment in which the present invention operates, FIG. 2a illustrates an example of a data processing system 200 illustrating an exemplary client or server computer system in which the features of the present invention may be implemented. As illustrated, data processing or computer system 200 is comprised of a system unit 202, output devices such as display device 204 and printer 210, and input devices such as keyboard 208, and mouse 206. Data processing system 200 receives data for processing by the manipulation of input devices 208 and 206 or directly from fixed or removable media storage devices such as disk 212 and network connection interfaces (not illustrated). Data processing system 200 then processes data and presents resulting output data via output devices such as display device 204, printer 210, fixed or removable media storage devices like disk 212 or network connection interfaces.

Referring now to FIG. 2b, there is depicted a high-level block diagram of the components of a data processing system 200 such as that illustrated by FIG. 2a. In a conventional computer system, system unit 202 includes a processing device such as processor 220 in communication with main memory 222 which may include various types of cache, random access memory (RAM), or other high-speed dynamic storage devices via a local or system bus 214 or other communication means for communicating data between such devices. Main memory 222 is capable of storing data as well as instructions to be executed by processor 220 and may be used to store temporary variables or other intermediate information during execution of instructions by processor 220. Computer system 200 also comprises a read only memory (ROM) and/or other static storage devices 224 coupled to local bus 214 for storing static information and instructions for processor 220. System unit 202 of data processing system 200 also features an expansion bus 216 providing communication between various devices and devices attached to the system bus 214 via bus bridge 218. A data storage device 228, such as a magnetic disk 212 or optical disk such as a CD-ROM and its corresponding drive may be coupled to data processing system 200 for storing data and instructions via expansion bus 216. Computer system 200 can also be coupled via expansion bus 216 to a display device 204, such as a cathode ray tube (CRT) or a liquid crystal display (LCD), for displaying data to a computer user such as generated meeting package descriptions and associated images. Typically, an alphanumeric input device 208, including alphanumeric and other keys, is coupled to bus 216 for communicating information and/or command selections to processor 220. Another type of user input device is cursor control device 206, such as a conventional mouse, trackball, or cursor direction keys for communicating direction information and command selection to processor 220 and for controlling cursor movement on display 204.

Alternatively, a client 102 can be implemented as a network computer or thin client device, such as the WebTV Networks™ Internet terminal or the Oracle™ NC. Client 102 may also be a laptop or palm-top computing device, such as the Palm Pilot™. Client 102 could also be implemented in a robust cellular telephone, where such devices are currently being used with Internet micro-browsers. Such a network computer or thin client device does not necessarily include all of the devices and features of the above-described exemplary computer system; however, the functionality of the present invention or a subset thereof may nevertheless be implemented with such devices.

A communication device 226 is also coupled to bus 216 for accessing remote computers or servers, such as server 100, or other servers via the Internet, for example. The communication device 226 may include a modem, a network interface card, or other well-known interface devices, such as those used for interfacing with Ethernet, Token-ring, or other types of networks. In any event, in this manner, the computer system 200 may be coupled to a number of servers 100 via a network infrastructure such as that illustrated in FIG. 1 and described above.

The system of the present invention includes software, information processing hardware, and various processing steps, which will be described below. The features and process steps of the present invention may be embodied in machine or computer executable instructions embodied within media such as disk 212. The instructions can be used to cause a general purpose or special purpose processor, which is programmed with the instructions to perform the steps of the present invention. Alternatively, the features or steps of the present invention may be performed by specific hardware components that contain hard-wired logic for performing the steps, or by any combination of programmed computer components and custom hardware components. While embodiments of the present invention will be described with reference to the World-Wide Web, the method and apparatus described herein is equally applicable to other network infrastructures or other data communications systems.

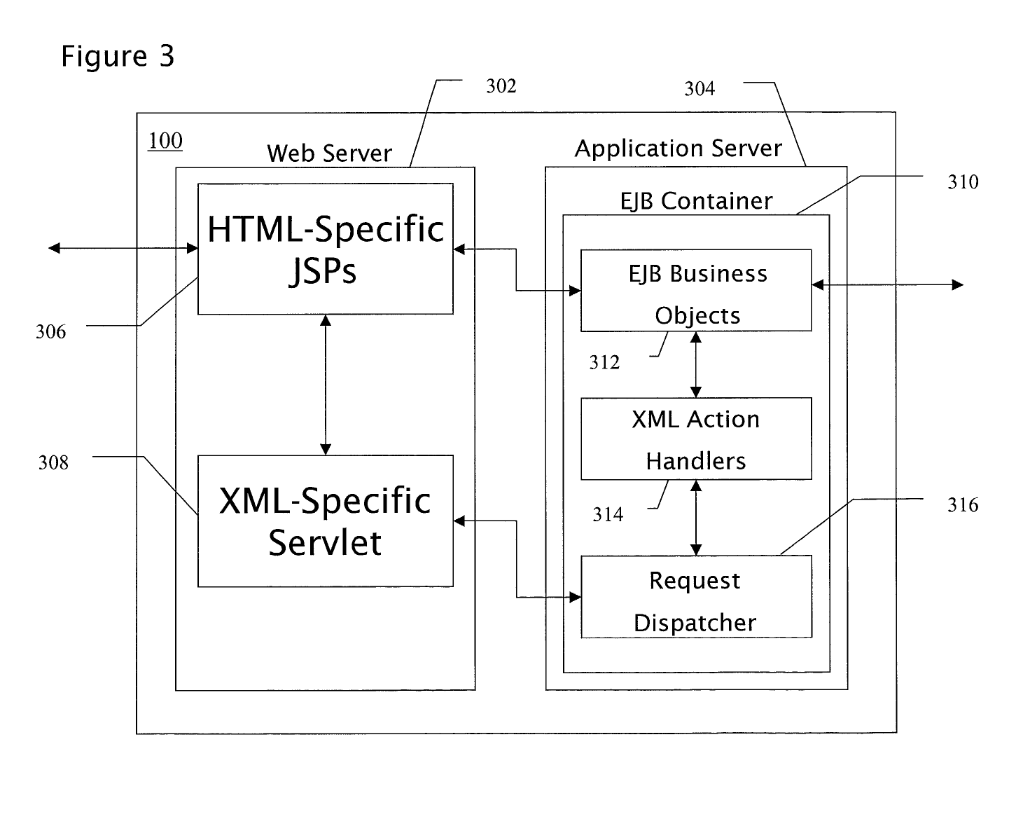

Referring now to FIG. 3, a more detailed view of the meeting package reservation server 100 of the present invention is illustrated. Meeting package reservation server 100 includes web server 302 and application server 304. In the illustrated embodiment, web server 302 functions as an interface between meeting package reservation server 100 and the various clients 102 by presenting a user interface via HTML-specific Java Server Pages (JSPs) 306. HTML-specific JSPs running on web server 302 receive user input and client requests for HTML pages and invoke Enterprise Java Bean (EJB) Business Object 312 methods either directly through methods of the EJB Business Object's container 310 for meeting facility client 104 requests, or indirectly through XML-specific Servlet 308 for meeting planner client 106 requests, in response. Following the invocation of an EJB Business Object method, the HTML-specific JSPs 306 receive responses either from XML-specific Servlet 308 or from EJB Business Objects 312 directly which are translated into the appropriate HTML page format and transmitted to the requesting client browser application.

To process client HTML page requests from meeting planner client 106, HTML-specific JSPs 306 translate user input into XML data bundles which are transmitted to XML-specific Servlet 308 along with the received client XML requests. Once received by XML-specific Servlet 308, the XML data bundles and client requests are translated into EJB Business Object method calls via Request Dispatcher 316 as shown. In the illustrated embodiment, HTTP or Secure HTTP is used for communication between HTML-specific JSPs and XML-specific Servlet 308, whereas Remote Method Invocation (RMI) and Internet Inter-ORB Protocol (IIOP) are utilized for communication between HTML-specific JSPs 306 and EJB Business objects 312 and between XML-specific Servlet 308 and Request Dispatcher 316.

In the depicted embodiment of FIG. 3, application server 304 functions as an interface between meeting package reservation server 100 and storage device 110 via a database server (not illustrated). Application server 304 as illustrated contains an EJB container 310 which functions as the interface between component Enterprise Java Bean objects and specific Java classes and EJB Clients such as HTML-specific JSPs 306 and XML-specific Servlet 308. Application server 304 implements the business logic of the system and performs transaction calls to the database server in order to store and query data from storage device 110. In one embodiment of the present invention, Application Server 304 further includes Request Dispatcher 316 which parses and analyzes XML requests received from XML-specific Servlet 308 and calls a corresponding XML Action Handler java class 314 which in turn invokes or requests EJB Business Object 312 methods. Request Dispatcher 316 receives responses from EJB Business Object 312 following a request via the XML Action Handler class 314 and forwards the received response back to XML-specific Servlet 308 in the appropriate form. In the illustrated embodiment, EJB objects communicate with each other via RMI/IIOP or direct references and with the storage device 110 and its associated database server via the Java Database Connectivity (JDBC) application program interface.

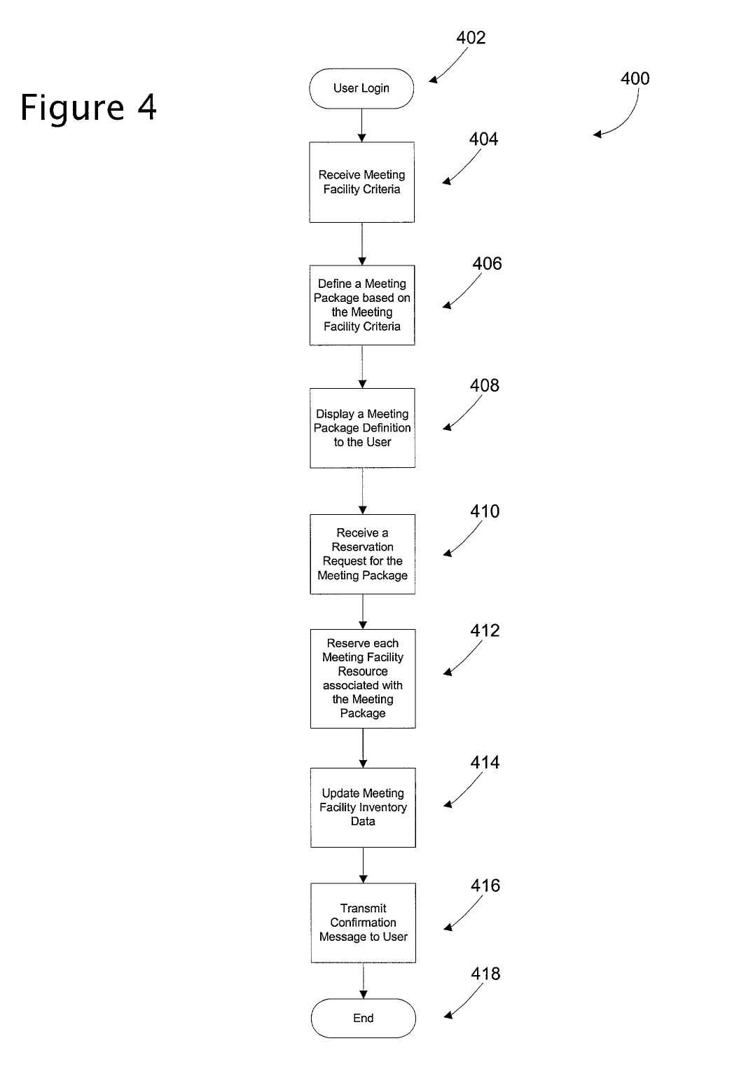

Referring now to FIG. 4, a high-level logic flowchart of one embodiment of the method of the present invention is illustrated. The process illustrated by FIG. 4 begins by allowing a user to log in (block 402). In the illustrated embodiment of the present invention the described user is a meeting planner utilizing a meeting planner client 106 as described herein. According to another embodiment, the user is an employee of a meeting facility and the progression of the illustrated process is varied accordingly. Next, meeting facility criteria are received (block 404) from the user via a graphical interface generated by web server 302 as previously described. A meeting package is then defined (block 406) based upon the received meeting facility criteria including meeting room and guest room meeting facility resources. In an alternative embodiment, the received meeting facility criteria also include desired food and beverage service meeting facility resources. The meeting package definition is then displayed to the user for potential selection (block 408). In an alternative embodiment the resulting meeting package definition may be displayed to a user other than the provider of the meeting facility criteria. For example, a meeting package definition or the Uniform Resource Locator (URL) of a meeting package definition page could be transmitted via electronic mail to a third party such as a meeting budget coordinator. Thereafter, a reservation request is received from the user for the displayed meeting package (block 410). Next, according to the illustrated embodiment, each meeting facility resource associated with the displayed and selected meeting package is reserved in response to the receipt of the reservation request (block 412). Once the meeting facility resources have been reserved, meeting facility inventory, stored within storage device 110, is updated to reflect the change in that meeting facility's availability (block 414). A confirmation message is then transmitted to the user (block 416) and thereafter the process terminates (block 418).

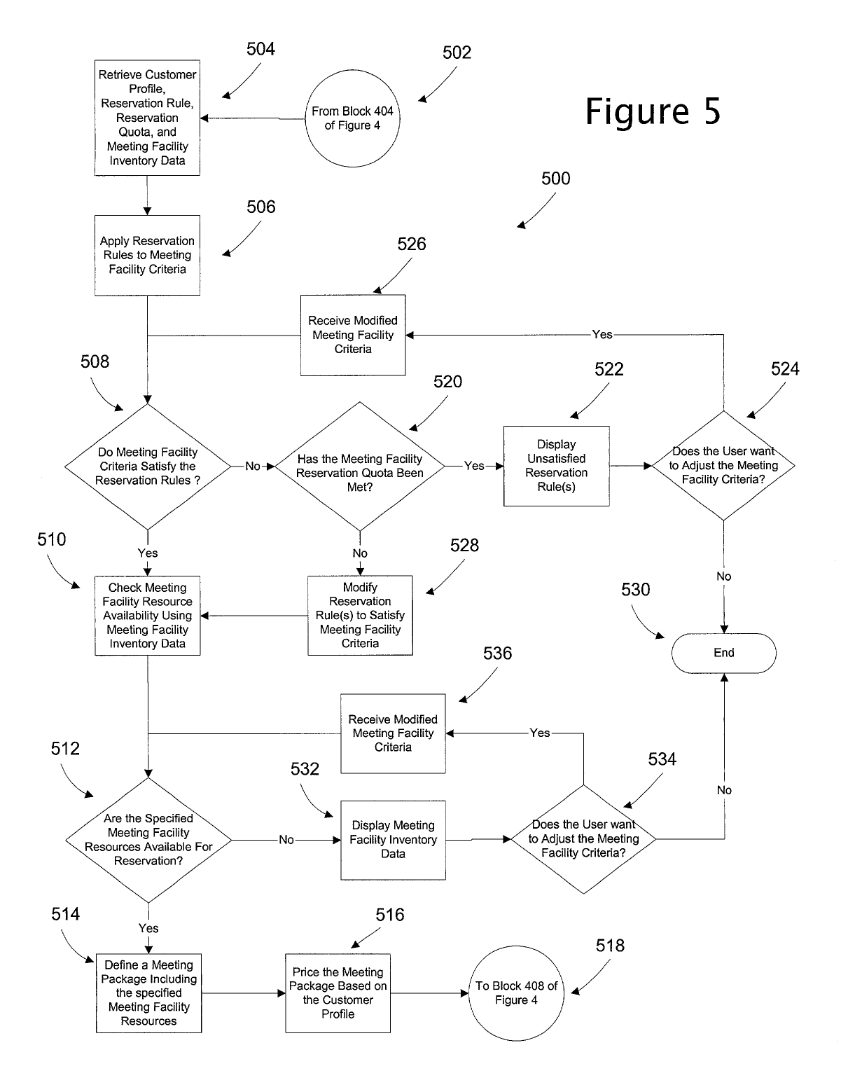

Referring now to FIG. 5, a high-level logic flowchart depicting one embodiment of the definition of a meeting package shown in FIG. 4 is illustrated. The process depicted by FIG. 5 is entered from block 404 of FIG. 4 (block 502). Next, a customer profile, a reservation rule, a reservation quota, and meeting facility inventory are retrieved from storage device 110 (block 504). According to one embodiment of the present invention, meeting facility inventory data includes real-time inventory data which is received from and updated utilizing meeting facility client 104. Thereafter the retrieved reservation rule is applied (block 506) to determine whether the user-input meeting facility criteria satisfy the retrieved reservation rule (block 508).

If the retrieved meeting facility reservation rule is satisfied, then the availability of each of the meeting facility resources associated with the meeting package definition is determined using the aforementioned meeting facility inventory data (block 510). Otherwise it is next determined whether the reservation quota is satisfied. In one embodiment the retrieved reservation quota is simply a percentage of hotel guest room occupancy or utilization over the date range specified in the meeting facility criteria. One alternative embodiment of the present invention contemplates a reservation quota including a current annual revenue figure for the associated meeting facility. If the reservation quota is satisfied, each unsatisfied reservation rule is displayed for the user (block 522) who is prompted to adjust the desired meeting facility criteria (block 524) to satisfy the displayed reservation rule or to terminate the process (block 530).

Any modified meeting facility criteria are received (block 526) and the process returns to its previous state illustrated by the status immediately following block 506 of FIG. 5. If the meeting facility reservation quota is not satisfied, the unsatisfied reservation rule(s) may be modified (block 528) to comply with the desired meeting facility criteria in order to increase the likelihood that the reservation quota of a particular facility will be met. If the reservation rule(s) is modified to comply with the user-specified meeting facility criteria the availability of the designated meeting facility resources is determined as previously described (block 510).

After the meeting facility inventory data has been examined with respect to the specified meeting facility criteria (block 510) a determination is made whether the meeting facility resources specified by the facility criteria are available to be reserved (block 512). If sufficient meeting facility resources are available to cover those desired by the user as described in the meeting facility criteria then a meeting package definition is generated using the specified meeting facility resources (block 514), a price for the defined meeting package is generated based upon the retrieved customer profile (block 516), and the meeting package definition process ceases and the overall process continues to the state illustrated by block 408 of FIG. 4 (block 518). In one embodiment of the present invention, customer profile includes a customer type designation such as corporate or government which entitles the designated customer to reduced prices for hotel guest rooms or other services. If however, the specified meeting facility resources are not available for reservation as determined from the meeting facility inventory data (block 512), the meeting facility's inventory data is displayed to the user (block 532) in order to allow the user an opportunity to effectively modify their preferred meeting dates, the quantity of a particular desired facility resource or other meeting facility criteria to utilize available resources (block 534). The user is then given the option to either terminate the process (block 530) or provide modified meeting facility criteria (block 536) and continue the process at its previous state illustrated by the status immediately following block 510 of FIG. 5.

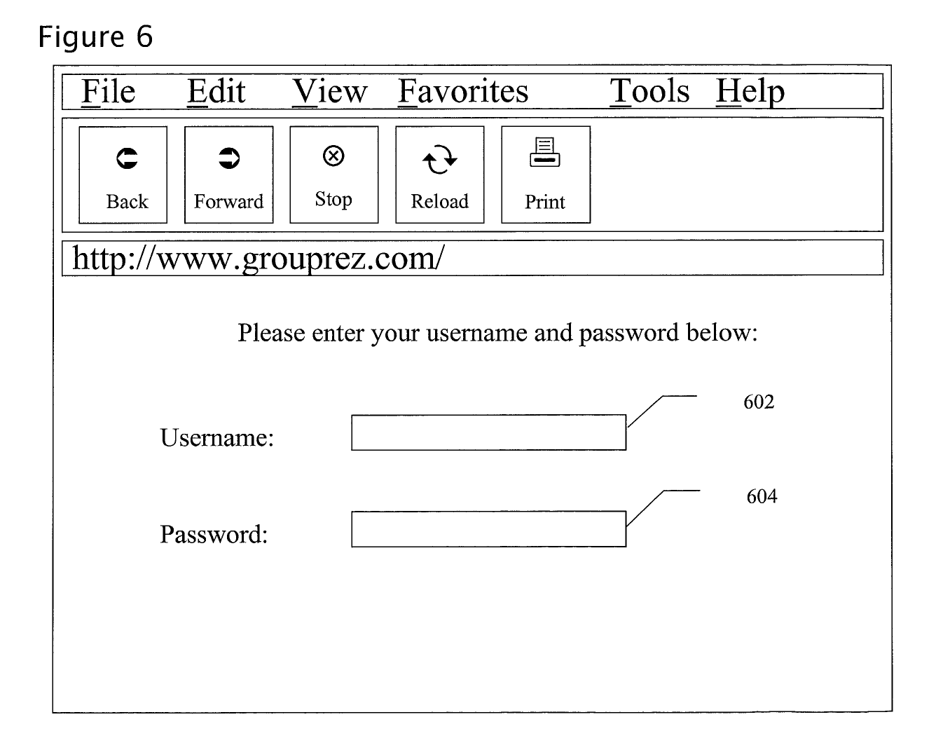

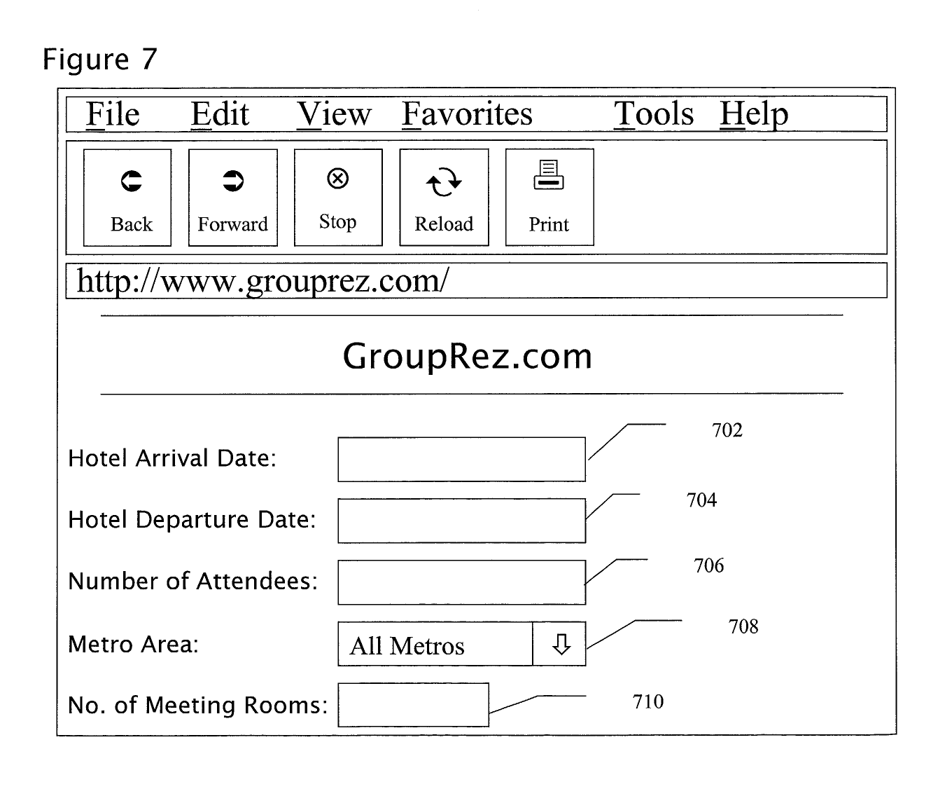

Now with reference to FIGS. 6-14, display output of a browser client application according to one embodiment of the present invention is illustrated. Referring now to FIG. 6, a login screen is illustrated with which a user desiring to utilize the method of the present invention may provide a username 602 and password 604 in order to gain access to meeting package reservation server 100 via a meeting planner client 106. In FIG. 7, a meeting facility criteria input screen of meeting planner client 106 is illustrated. Meeting facility criteria include, in the illustrated embodiment, a hotel arrival 702 and departure date 704, a number of attendees 706 of the meeting or event, the preferred geographic location of the meeting 708, and the desired number of meeting rooms for the event 710.

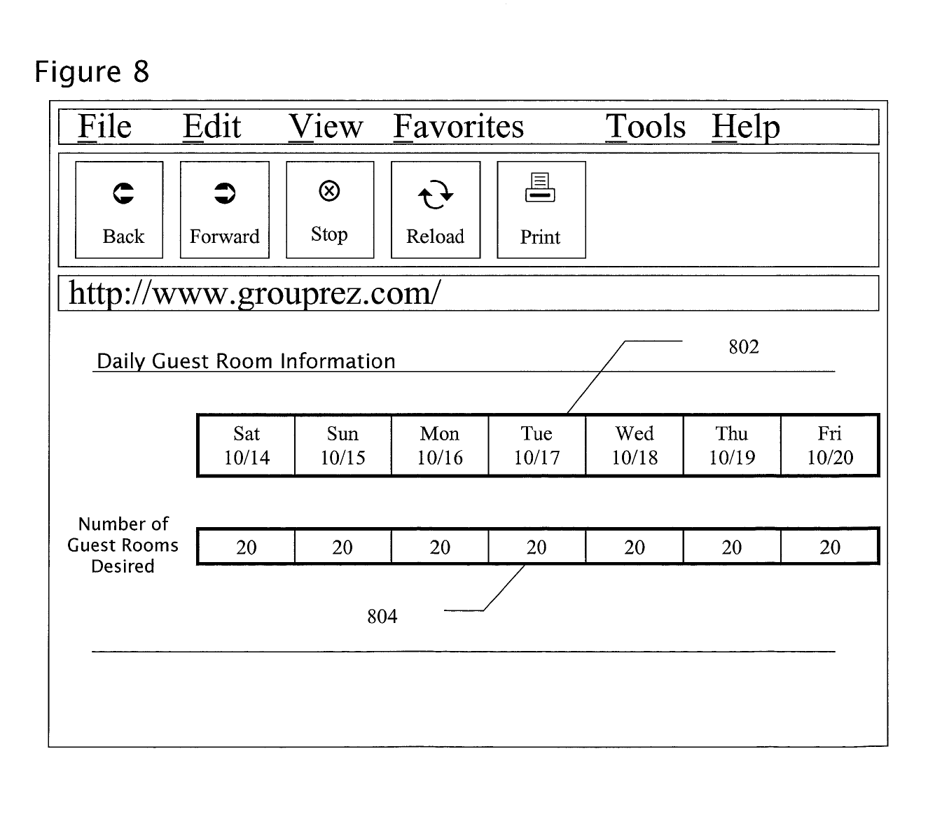

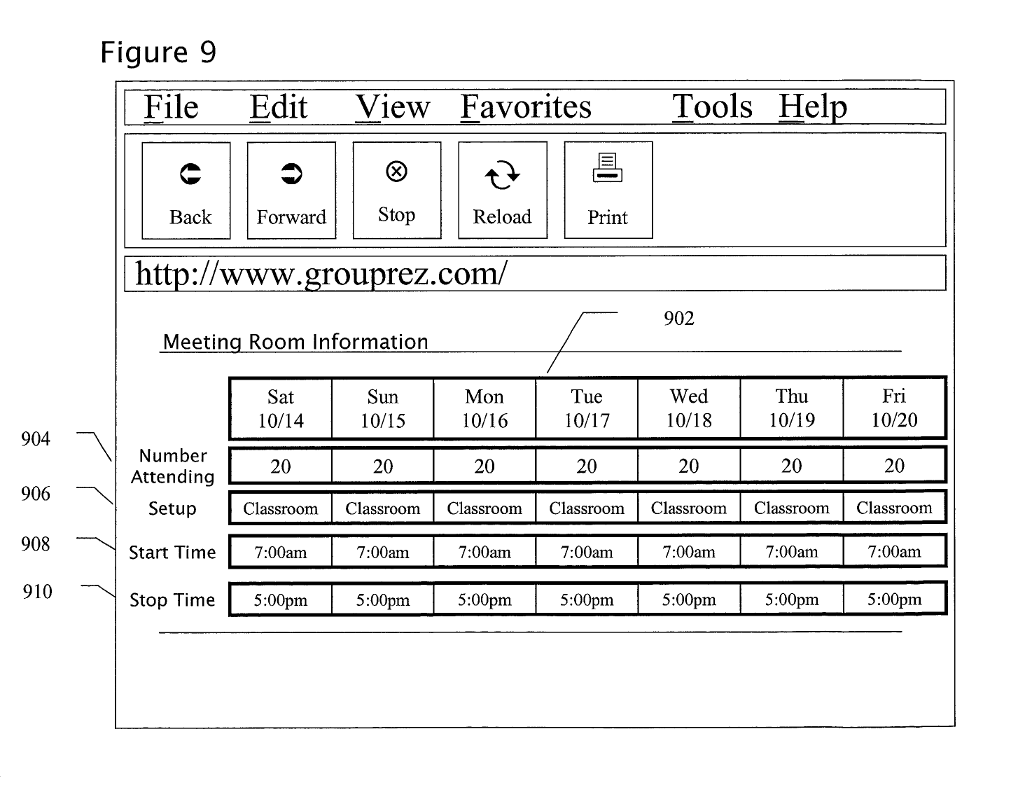

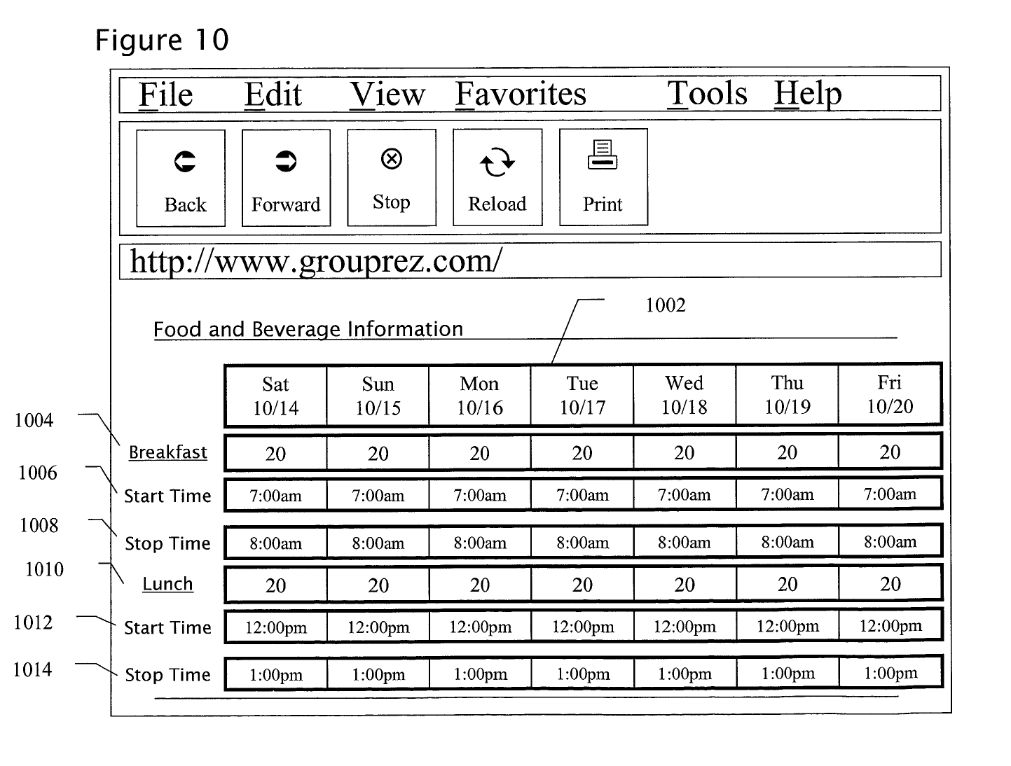

Referring now to FIGS. 8-10, meeting facility criteria input screens of meeting planner client 106 are illustrated in greater detail. In FIG. 8, a meeting planner's hotel guestroom requirements for a meeting are organized in a calendar format 802 and consequently the number of needed hotel guestrooms may be specified by a meeting planner with finer granularity than that possible with the input screen of FIG. 7. In the illustrated embodiment, a calendar 802 encompassing the meeting dates specified by the hotel arrival 702 and departure 704 dates including default hotel guestroom requirement quantity values 804 for each of the calendar days corresponding to the attendee number of FIG. 7 is displayed. A meeting planner could then modify the default hotel guestroom quantity values 804 as needed by their actual reservation requirements. In FIG. 9, meeting room information is organized in a similar calendar format 902 including a daily value for the number of meeting attendees 904, the desired meeting room layout or setup 906, as well as start 908 and stop 910 times all set to meeting planner-variable default values. Referring now to FIG. 10, a meeting planner's food and beverage requirements are displayed in a manner analogous to that previously described including a meeting calendar 1002, the number of meeting attendees who will be present at each meal or service 1004, 1010 and each meal or services' start 1006, 1012 and stop 1008, 1014 times.

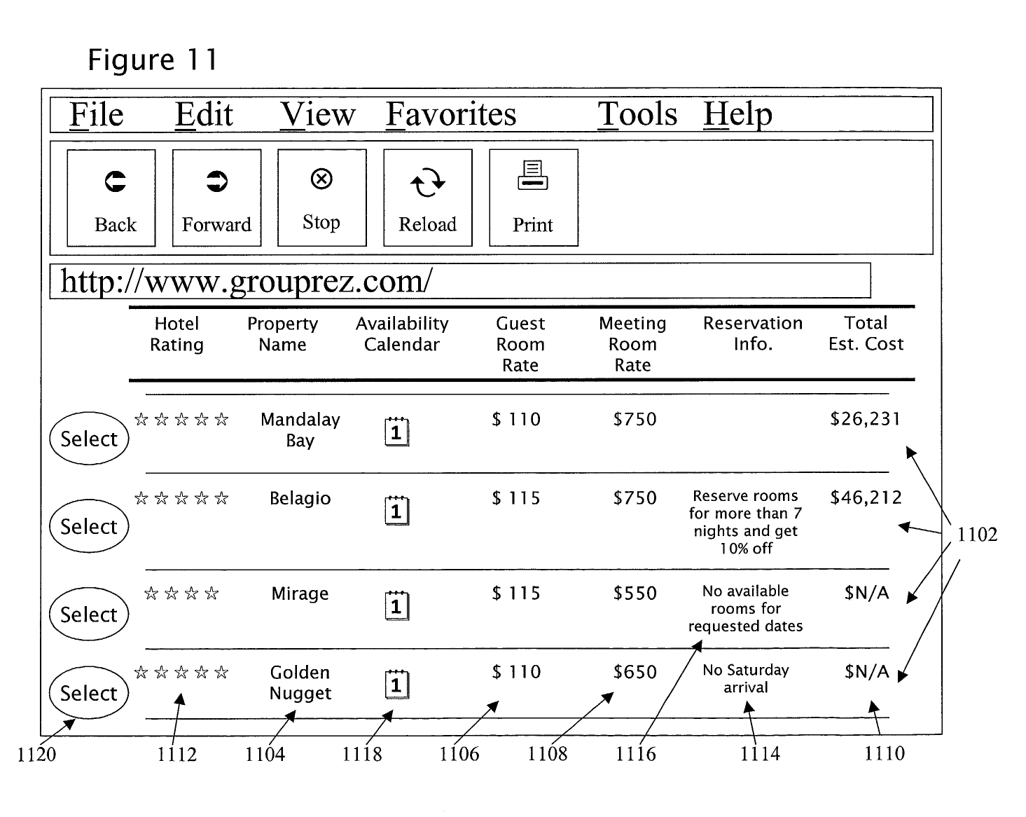

Referring now to FIG. 11, a meeting package definition display screen of meeting planner client 106 is illustrated including a plurality of meeting package definitions 1102 for each of a group of meeting facilities 1104. The illustrated embodiment includes comparison information for each of the meeting package definitions including guestroom rates 1106, meeting room rates 1108, estimated total meeting cost 1110, and hotel quality rating 1112. Additional reservation information is also included for some of the displayed meeting facilities including, for example, the display of unsatisfied reservation rule 1114. In the event a meeting facility is unavailable due to a lack of capacity as illustrated by reservation information 1116, a meeting planner may access an availability calendar showing the availability of meeting facility resources by selecting an availability calendar icon 1118 corresponding to the appropriate meeting facility to determine an optimal time for holding a particular meeting at that facility. The illustrated embodiment further includes a meeting package reservation icon 1120 for selecting a given meeting package for reservation.

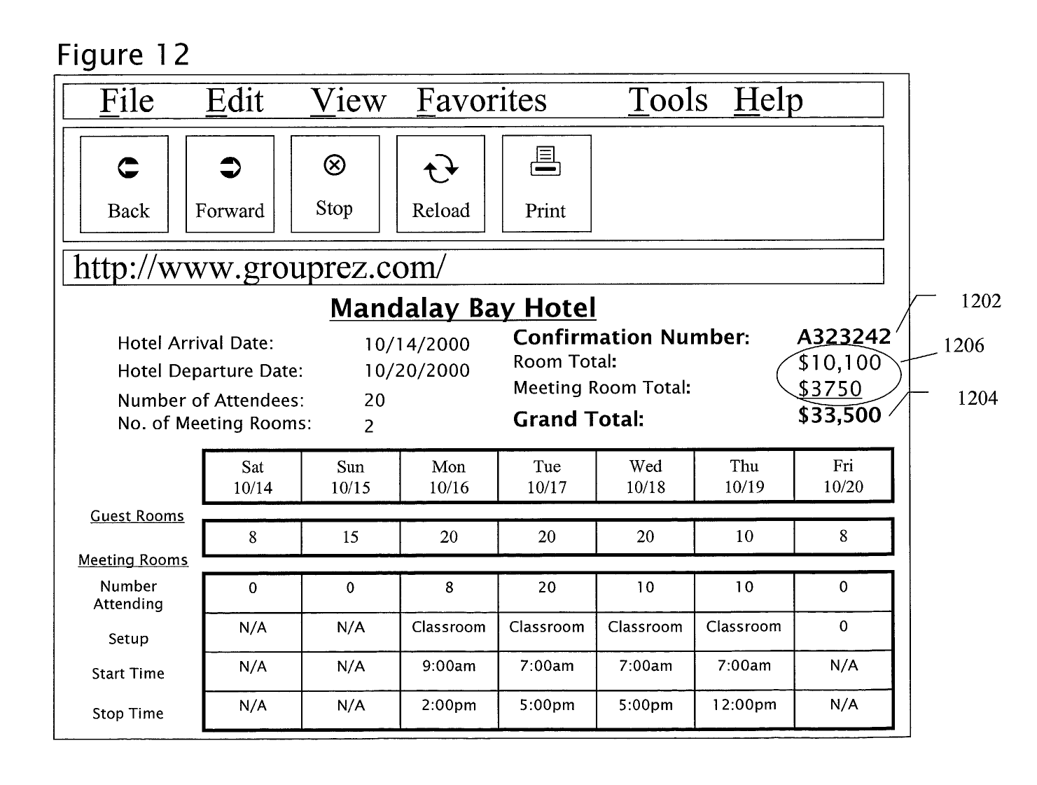

With reference now to FIG. 12, a meeting package reservation confirmation screen of meeting planner client 106 is illustrated. In addition to including summary information of the planner-specified meeting facility criteria as adjusted during the meeting package reservation process as shown, the confirmation screen also includes a meeting package confirmation number 1202, a total, actual cost figure 1204, and a cost breakdown 1206.

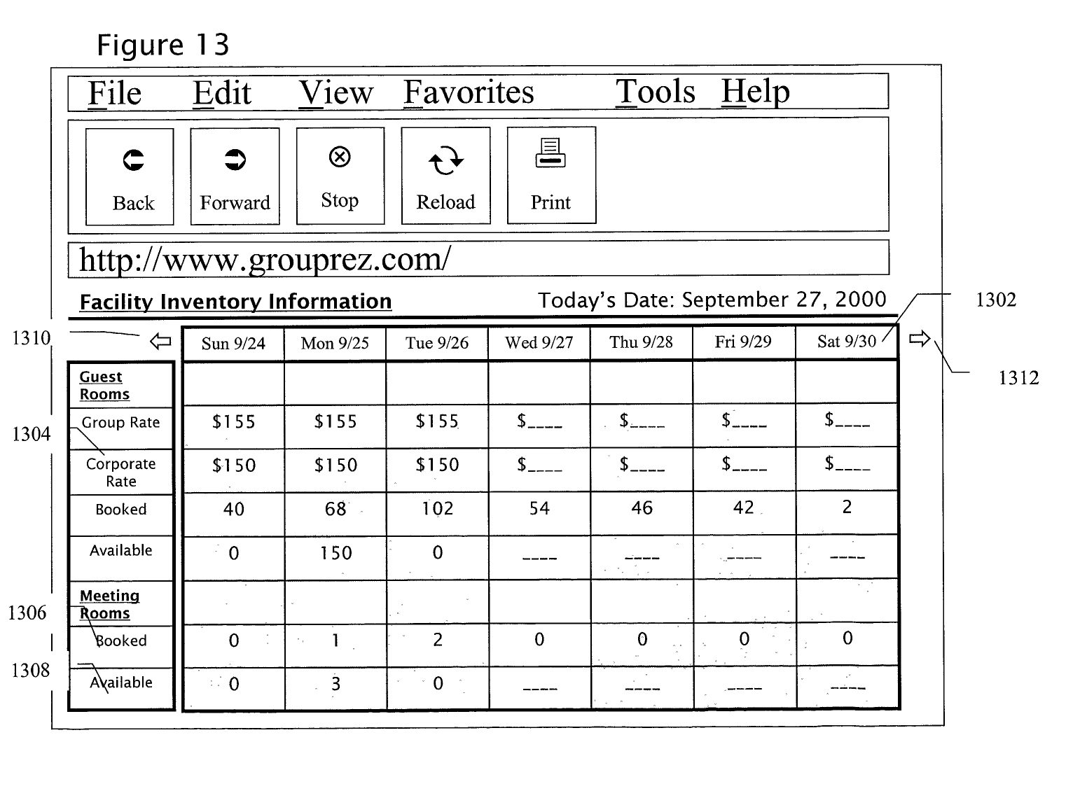

Referring now to FIG. 13, a facility inventory information screen of meeting facility client 104 is illustrated. Utilizing a calendar format 1302 similar to that described above herein, a meeting facility employee may adjust room pricing values such as the corporate guestroom rate 1304 and resource availability such as the number of booked 1306 or available 1308 meeting rooms. Furthermore, in one embodiment of the present invention, a user can adjust the window of time viewed via the facility inventory information screen by manipulating a calendar icon 1310 to go backward a fixed increment in time or a calendar icon 1312 to go forward in time a fixed increment.

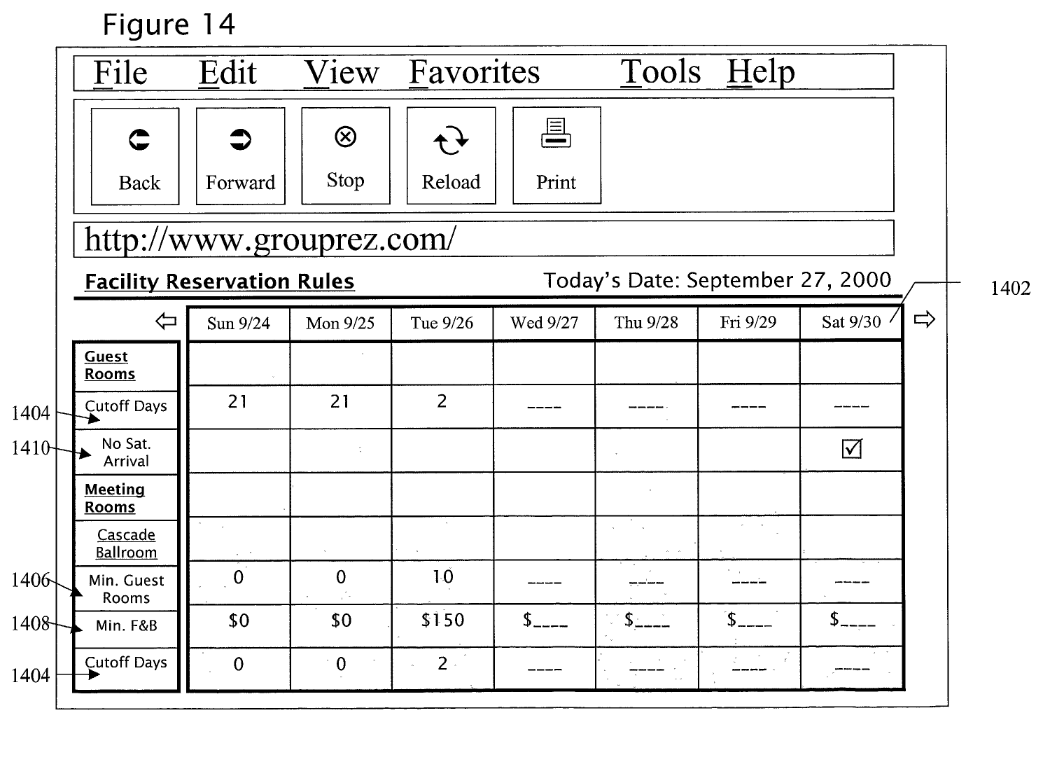

With reference to FIG. 14, a facility reservation rule screen of meeting facility client 104 is illustrated. In one embodiment of the present invention a user may adjust reservation rules displayed using a calendar format 1402. Various reservation rules are illustrated by FIG. 14, including guestroom and meeting room “cutoff” days 1404. The cutoff days reservation rule, utilized to avoid selling meeting or guestroom space too close to an actual event, reduces the availability of a meeting facility resource to zero for any reservation requests within a cutoff number of days from the actual event. FIG. 14 further depicts reservation rules requiring that a certain number of hotel guestrooms be reserved in conjunction with the reservation of a hotel meeting room 1406, and that a certain dollar value of food and beverages be bought in conjunction with such a reservation 1408. Lastly, FIG. 14 illustrates a reservation rule preventing the reservation of hotel guestrooms with an arrival date of Saturday 1410. In an alternative embodiment of the present invention, an “air wall” reservation rule (not illustrated) associated with a particular meeting room is also included. The air wall rule is a factor or multiplier which describes the number of subdivisions a meeting room space can be divided into for reservation using either physical dividers such as moveable room partitions, booths, etc. or intangible means such as area or section assignments for each meeting or event. Accordingly, the “air wall” factor is utilized to determine capacity and availability of meeting room space and as a reservation rule requiring that, for example, a certain number of meeting room subdivisions be reserved, or that the reservation of subdivided meeting room space is acceptable.

Although the present invention is described herein with reference to a specific preferred embodiment, many modifications and variations therein will readily occur to those with ordinary skill in the art. Accordingly, all such variations and modifications are included within the intended scope of the present invention as defined by the following claims.

What is claimed is:

1. A method comprising:
defining a meeting package including a plurality of meeting facility resources, said plurality of meeting facility resources including a meeting room and a guest room of a meeting facility;
receiving a reservation request for said meeting package from a user; and
reserving each of said plurality of meeting facility resources in response to receiving said reservation request.

2. The method as set forth in claim 1, further comprising:
defining a customer profile for said user, wherein defining a meeting package comprises determining a price for said meeting package based on said customer profile.

3. The method as set forth in claim 1, further comprising:
storing inventory data for said meeting facility, wherein defining a meeting package comprises:
determining whether each of said plurality of meeting facility resources is available for reservation utilizing said inventory data; and
displaying said inventory data for said meeting facility in response to a determination that each of said plurality of meeting facility resources is not available for reservation,
and further wherein reserving each of said plurality of meeting facility resources in response to receiving said reservation request comprises:
reserving each of said plurality of meeting facility resources in response to a determination that each of said plurality of meeting facility resources is available for reservation.

4. The method as set forth in claim 3, wherein reserving each of said plurality of meeting facility resources in response to receiving said reservation request further comprises updating said inventory data.

5. The method as set forth in claim 1, wherein:
defining a meeting package comprises defining a meeting package for each of a plurality of meeting facilities; and
receiving a reservation request for said meeting package from a user comprises receiving a user selection of one of said plurality of meeting packages.

6. The method as set forth in claim 1, wherein reserving each of said plurality of meeting facility resources comprises transmitting a confirmation message to said user.

7. The method as set forth in claim 1, further comprising:
receiving meeting facility criteria including a preferred meeting date, a guest room quantity, and a meeting room quantity, wherein defining a meeting package comprises defining said meeting package based on said meeting facility criteria.

8. The method as set forth in claim 7, further comprising:
defining a reservation rule for said meeting facility, wherein defining a meeting package based on said meeting facility criteria comprises:
determining whether said meeting facility criteria satisfy said reservation rule; and
identifying said reservation rule to said user in response to a determination that said meeting facility criteria do not satisfy said reservation rule.

9. The method as set forth in claim 8, wherein defining a meeting package based on said meeting facility criteria further comprises:
modifying one of said meeting facility criteria in response to a determination that said meeting facility criteria do not satisfy said reservation rule; and
defining said meeting package based on said modified meeting facility criterion.

10. The method as set forth in claim 9, wherein modifying one of said meeting facility criteria comprises:
prompting said user to adjust said meeting facility criteria; and
receiving an adjusted meeting facility criterion in response to said prompting.

11. The method as set forth in claim 7, further comprising:
defining a reservation rule for said meeting facility, wherein defining a meeting package based on said meeting facility criteria comprises:
determining whether said meeting facility criteria satisfy said reservation rule; and
modifying said reservation rule in response to a determination that said meeting facility criteria do not satisfy said reservation rule.

12. The method as set forth in claim 11, further comprising:
defining a reservation quota for said meeting facility, wherein modifying said reservation rule comprises:
determining whether said reservation quota is satisfied; and
modifying said reservation rule in response to a determination that said reservation quota is not satisfied.

13. The method as set forth in claim 7, wherein:
receiving meeting facility criteria comprises receiving food and beverage information; and
defining a meeting package based on said meeting facility criteria comprises defining a meeting package including a plurality of meeting facility resources, said plurality of meeting facility resources including food and beverage service.

14. A data processing system-readable medium having a plurality of instructions executable by a data processing system embodied therein, wherein said instructions when executed cause said data processing system to:
define a meeting package including a plurality of meeting facility resources, said plurality of meeting facility resources including a meeting room and a guest room of a meeting facility;
receive a reservation request for said meeting package from a user; and
reserve each of said plurality of meeting facility resources in response to receiving said reservation request.

15. The data processing system-readable medium of claim 14, wherein:
said plurality of instructions when executed further cause said data processing system to define a customer profile for said user, and
said instructions causing said data processing system to define a meeting package cause said data processing system to determine a price for said meeting package based on said customer profile.

16. The data processing system-readable medium of claim 14, wherein:
said plurality of instructions when executed further cause said data processing system to store inventory data for said meeting facility,
said instructions causing said data processing system to define a meeting package cause said data processing system to:
determine whether each of said plurality of meeting facility resources is available for reservation utilizing said inventory data; and
display said inventory data for said meeting facility in response to a determination that each of said plurality of meeting facility resources is not available for reservation, and
said instructions causing said data processing system to reserve each of said plurality of meeting facility resources in response to receiving said reservation request cause said data processing system to:
reserve each of said plurality of meeting facility resources in response to a determination that each of said plurality of meeting facility resources is available for reservation.

17. The data processing system-readable medium of claim 14, wherein:
said plurality of instructions when executed further cause said data processing system to receive meeting facility criteria including a preferred meeting date, a guest room quantity, and a meeting room quantity, and
said instructions causing said data processing system to define a meeting package cause said data processing system to define said meeting package based on said meeting facility criteria.

18. The data processing system-readable medium of claim 17 wherein:
said plurality of instructions when executed further cause said data processing system to define a reservation rule for said meeting facility, and
said instructions causing said data processing system to define a meeting package based on said meeting facility criteria cause said data processing system to:
determine whether said meeting facility criteria satisfy said reservation rule; and
identify said reservation rule to said user in response to a determination that said meeting facility criteria do not satisfy said reservation rule.

19. The data processing system-readable medium of claim 17 wherein:
said plurality of instructions when executed further cause said data processing system to define a reservation rule for said meeting facility, and
said instructions causing said data processing system to define a meeting package based on said meeting facility criteria cause said data processing system to:
determine whether said meeting facility criteria satisfy said reservation rule; and
modify said reservation rule in response to a determination that said meeting facility criteria do not satisfy said reservation rule.

20. The data processing system-readable medium of claim 19, wherein:
said plurality of instructions when executed further cause said data processing system to define a reservation quota for said meeting facility, and
said instructions causing said data processing system to define a meeting package based on said meeting facility criteria further cause said data processing system to:
determine whether said reservation quota is satisfied; and
modify said reservation rule in response to a determination that said reservation quota is not satisfied.

21. A data processing system comprising:
a storage device to store a meeting package definition for a meeting package including a plurality of meeting facility resources, said plurality of meeting facility resources including a meeting room and a guest room of a meeting facility;
an input device; and
a processing device to create said meeting package definition, to receive a reservation request for said meeting package from a user via said input device, and to reserve each of said plurality of meeting facility resources in response to receiving said reservation request.

22. The data processing system as set forth in claim 21, wherein:
said storage device comprises a storage device to store a customer profile for said user, and
said processing device comprises a processing device to determine a price for said meeting package based upon said customer profile.

23. The data processing system as set forth in claim 21, further comprising a display device; wherein:
said storage device comprises a storage device to store inventory data for said meeting facility, and
said processing device comprises a processing device to:
determine whether each of said plurality of meeting facility resources is available for reservation utilizing said inventory data;
display said inventory data for said meeting facility via said display device in response to a determination that each of said plurality of meeting facility resources is not available for reservation; and
reserve each of said plurality of meeting facility resources in response to a determination that each of said plurality of meeting facility resources is available for reservation.

24. The data processing system as set forth in claim 21, wherein:
said processing device comprises a processing device to receive meeting facility criteria including a preferred meeting date, a guest room quantity, and a meeting room quantity via said input device, and to create said meeting package definition based upon said meeting facility criteria.

25. The data processing system as set forth in claim 24, further comprising a display device, wherein:
said storage device comprises a storage device to store a reservation rule for said meeting facility, and
said processing device comprises a processing device to:
determine whether said meeting facility criteria satisfy said reservation rule; and
display said reservation rule to said user via said display device in response to a determination that said meeting facility criteria do not satisfy said reservation rule.

26. The data processing system as set forth in claim 24, wherein:
said storage device comprises a storage device to store a reservation rule for said meeting facility, and
said processing device comprises a processing device to:
determine whether said meeting facility criteria satisfy said reservation rule; and
modify said reservation rule in response to a determination that said meeting facility criteria do not satisfy said reservation rule.

27. The data processing system as set forth in claim 26, wherein:
said storage device comprises a storage device to store a reservation quota for said meeting facility, and
said processing device further comprises a processing device to:
determine whether said reservation quota is satisfied; and
modify said reservation rule in response to a determination that said reservation quota is not satisfied.

28. A communications network comprising:
a meeting planner client to receive meeting facility criteria and a reservation request for a meeting package including a plurality of meeting facility resources from a user, said plurality of meeting facility resources including a meeting room and a guest room of a meeting facility;
a data storage device to store a customer profile for said user, a reservation rule and inventory data for said meeting facility, and a meeting package definition for said meeting package; and
a meeting package reservation server coupled to said meeting planner client via said communications network to create said meeting package definition utilizing said customer profile, said reservation rule, and said inventory data, to display said meeting package definition to said user and to receive said reservation request from said user via said meeting planner client, and to reserve each of said plurality of meeting facility resources in response to receiving said reservation request.
